(19) United States
(12) Patent Application Publication
(10) Pub. No.: US 2004/0267624 A1
(43) Pub. Date: Dec. 30, 2004

(54) Novel auction method

(76) Inventor: Gali Nuriel, Chicago, IL (US)

Correspondence Address: Gali Nuriel, Unit 502, 2045 West Concord PL, Chicago, IL, 60647, US

(21) Appl. No.: 10/603,484

(22) Filed: Jun. 25, 2003

(51) Int. Cl. G06F 17/60

(52) U.S. Cl. 705/26

(57) ABSTRACT

An auction method allows an individual the opportunity to purchase an item through bidding on an auction of the item at a fixed limit price or lower. A set number of bidders each pay a nominal fee to bid on the item and bid at any price lower than the set limit price. If more than one person bids the same amount on that item, his/her bids are eliminated. This process continues until the set number of people bid. The person with the highest unmatched bid will have the opportunity to buy that item for the price that he/she bid. The auction can also be timed out after a certain number of days.

### BACKGROUND OF THE INVENTION

1. Field of the Invention

The present invention generally relates to commerce methods and in particular, to a novel auction method for conducting sales of goods and services to enable a buyer to purchase an item at or below a set limit price.

2. Description of the Prior Art

Auctions have proliferated with the advent of the Internet and advances in communication. Many businesses use auctions and marketplaces to buy and sell goods and services and often enjoy great savings and efficiencies as a result. The essential premise of an auction is that prices are determined as a result of competition between bidders for items offered for sale or purchase. These benefits, however, are only realized when more than one bidder is competing for the same item. A number of different auctions styles and types have developed over the years to encourage different types of competitions among bidders, including English auctions, Dutch auctions, Japanese auctions, sealed-bid auctions, double auctions, multiple-unit auction, time interval auctions, call auctions, first price auctions, uniform second price auctions, bundle auctions, and multi-attribute auctions.

Auctions for sale of products have proven to be very popular and the success of the systems involve two major features. Typically with auction systems, there is the possibility to obtain the product at a very competitive price. In addition, there is the excitement and skill of the buyer who participates in the auction process and makes fast decisions whether to continue to participate or to recognize the price has become too high. The auction process, traditionally, has been a relatively fast process that changes quickly. The standard auction process involves users bidding for a particular product, and the product is sold to the highest bidder.

The dynamic nature of the auction process, in its traditional form, is attractive to a certain number of participants, but it is also an obstacle to a further group of participants who do not wish to rush their decision process. For this reason, there are other variations of the auction process where the time period for the auction is much longer and the feedback of information tends to be slower. Some auction processes do not provide any real time feedback, such as a silent auction process, where users merely submit their bid, which is confidential.

A further variation of the auction process is a reverse auction where the price of the product decreases in a set manner during the time period of the auction and each participant is provided with the current price, the quantity on hand and the time remaining in the auction. This type of auction, typically, takes place over a very short period of time and there is a flurry of activity in the last portion of the auction process. The actual auction terminates when there is no more product to be sold or the time period expires. A reverse auction process has been used very effectively in Holland for the sale of flowers to wholesalers.

Prior art U.S. Patent Application #20010056396, published Dec. 27, 2001 by Goino, puts forth auction methods, systems and servers that can satisfy requirements other than the price for a client. An auction client selects a desired one from time slide schemes from a terminal, and enters a due date in an associated entry field. For example, a due date advance scheme is a scheme in which a person who offers the soonest possible trading date from a due date is determined as a successful bidder. Also, specific details (paying-in, delivery and so on) on the trading date for a payment or delivery of an article, requested to a partner, are specified. This bid condition data is transmitted to the server through a network, and the server collects participants in a bid on a home page. The server receives trading dates offered from terminals of participants, and determines a participant who offers the trading date that most satisfies the trade due date condition offered by the client as a successful bidder.

Prior art U.S. Patent Application #20020147674, published Oct. 10, 2002 by Gillman, concerns an electronic buying system and method that dynamically matches, over the World Wide Web, a person or business entity requesting a specialized product with a person or entity capable of providing that product. The electronic buy system, which may function as a reverse auction, is utilized from personalized home pages for both buyers and suppliers. A buyer submits a request for a good including electronic specifications, and the suppliers respond to the request with bid proposals. The present system may include self-adjusting bids, and private auction centers, and suppliers may submit more than one bid for each specific request. The buyer may choose any bid, not only the lowest priced bid, as the winner.

Prior art U.S. Patent Application #20030018564, published Jan. 23, 2003 by Bonnier, illustrates a method of operating a game of chance, for fun or profit. Players first bid in an “auction” to qualify for the right to bet on the outcome of a pre-defined event. Winning an auctioning session does not guarantee receipt of the wager pool—the successful player/bidder wins a mere chance at the pooled value of the wagers of all prior bidding players. To win the pool the successful bidder must also have correctly predicted the outcome of the specified event. The manner in which (game operator) “house” risk is instead distributed to players permits a method in which the game operator may always receive revenues regardless of the event or its outcome. The auctioning sessions are run by a server, with no need of human auctioneers and end both at random (outside the control of the operator) and without notice to the players as a means of creating both suspense and credibility in the integrity of the game. In a preferred embodiment the game is globally accessible through the Internet, but may also run on private networks.

Prior art U.S. Pat. No. 5,794,219, issued Aug. 11, 1998 to Brown, provides a method of conducting an on-line auction that permits individual bidders to pool bids during a bidding session. The auction is conducted over a computer network that includes a central computer, a number of remote computers, and communication lines connecting the remote computers to the central computer. A number of bidding groups are registered in the central computer, each bidding group having a total bid for the item being auctioned. Bids entered from the remote computers are received in the central computer, each bid including a bid amount and a bid designation. Each bid amount is contributed to the total bid of the bidding group indicated by the bid designation. The bidding group having the largest total bid at the end of the bidding session wins the item being auctioned.

Prior art U.S. Pat. No. 6,023,686, issued Feb. 8, 2000 to Brown, shows a method for conducting an on-line bidding session to accumulate a collective bid for a property. The bidding session is conducted over a computer network that includes a central computer, a number of remote computers, and communication lines connecting the remote computers to the central computer. According to the method, at least one bidding group is registered in the central computer. The bidding group can be an association, institution, or group of investors formed for the purpose of bidding together for the property. The bidding group has a total bid for the property that is tracked in the central computer. The central computer receives bids entered from the remote computers by members of the bidding group. Each bid includes an individual bid amount that is contributed to the total bid of the group to accumulate the collective bid for the property.

Prior art U.S. Pat. No. 6,167,386, issued Dec. 26, 2000 to Brown, claims a method for conducting an on-line bidding session to accumulate a collective bid for a property. The bidding session is conducted over a computer network that includes a central computer, a number of remote computers, and communication lines connecting the remote computers to the central computer. According to the method, at least one bidding group is registered in the central computer. The bidding group can be an association, institution, or group of investors formed for the purpose of bidding together for the property. The bidding group has a total bid for the property that is tracked in the central computer. The central computer receives bids entered from the remote computers by members of the bidding group. Each bid includes an individual bid amount that is contributed to the total bid of the group to accumulate the collective bid for the property.

Prior art U.S. Pat. No. 6,499,018, issued Dec. 24, 2002 to Alaia, describes a method and system for conducting electronic auctions. A dynamic lot closing extension feature avoids collisions in closing times of multiple lots by dynamically extending the closing time of a subsequent lot if a preceding lot's closing time is extended to be too close to the subsequent lot's then-currently scheduled closing time. Scheduled closing times can be extended with a flexible overtime feature, in which the properties of the event triggering the extension and the duration of the overtime period(s) can be tailored to a particular auction, particular lots of products within an auction, and to the particular time within an auction process. The bidding status of a lot can be set to a “pending” status after the nominal closing time for submission of bids to allow bidders to alert the auction coordinator of technical problems in submission of bids. This allows the possibility for a lot to be return to open status for further bidding by all bidders. The auction may be paused by the auction coordinator to correct technical, market and miscellaneous problems that may arise during the course of an auction. Individual bid ceilings can be set for each bidder so that they are required to bid lower than certain thresholds determined in advance of the auction. Fail safe error detection is performed to prevent erroneous bids from entering the auction. The auction coordinator has the ability to override any erroneous bids that are entered to prevent prejudice to the auction.

Prior art U.S. Pat. No. 6,266,651, issued Jul. 24, 2001 to Woolston, discloses a computer-implemented two-tiered electronic market system that includes a data repository storing information corresponding to an inventory of one or more available items and a first-tier electronic market (e.g., a retail tier) that provides a first participant (e.g., a retail consumer) access to the inventory of one or more items in the data repository. The inventory is offered to the first participant under a first (e.g., retail) pricing scheme. The two-tiered electronic market system also includes a second-tier electronic market (e.g., a wholesale tier) that provides a second participant (e.g., a wholesale dealer), different from the first participant, access to the inventory of one or more items in the data repository. The inventory is offered to the second participant under a second (e.g., wholesale) pricing scheme different from the first pricing scheme. Electronic commerce is facilitated using an electronic auction system having at least a wholesale tier and a retail tier by presenting for auction an item description stored in a database operationally coupled to the electronic auction system. The presentation of the item includes a current retail bid amount. A wholesale bid is received from at least one wholesale-tier participant and the current retail bid amount is selectively displaced if the received wholesale bid increased by a predetermined amount is greater than the current retail bid.

Prior art U.S. Pat. No. 6,468,159, issued Oct. 22, 2002 to La Mura, indicates an enhanced system and method for carrying out online transactions and auctions using a “shopping games” mechanism module. The shopping games system provides for a mechanism scheme allowing “game moves” as well as bidding and message exchanging moves. The participants of the system may engage in game play in conjunction with an auction process to provide an entertaining and amusing environment for participants to carry out online transactions without limiting the participants to traditional auction “moves”.

Prior art U.S. Pat. No. 6,044,363, issued Mar. 28, 2000 to Mori, puts forth an automatic auction method that makes it unnecessary for bidders to stay before auction terminals at the time of auction. The method also makes auction transactions possible on an open network on which it is difficult to assure the on-line and real time properties. A plurality of auction ordering information pieces each containing a desired price, number of purchase, and a highest possible price in competition for the desired price and received from bidder terminals via on-line circuits are collected. Until an auction issue appears, the price is lowered. If there is at least one auction issue and a desired quantity which is the sum total of the numbers of purchase of the auction issues is not satisfied, then it is determined whether there is an auction issue coinciding in price by comparing the set price with (the desired price plus the highest possible price in competition). Until the desired quantity is satisfied, the price is raised.

Prior art U.S. Pat. No. 6,012,045, issued Jan. 4, 2000 to Barzilai, concerns a computer-based method of selling consumer products and consumer services that includes, in one embodiment, the utilization of a computer system, which maintains the electronic bid, auction and sales records, and a plurality of customer computers interconnected with the computer system via a telecommunications link. The computer system electronically establishes a virtual showroom accessible by the customer's computer that displays consumer goods and services and information regarding the commonly available selling price for each product and service. For example, the system displays the manufacturer's suggested retail price or MSRP, a minimum opening bid price, information regarding the make, model and manufacturer or distributor of the offered product or service, and bid cycle data revealing the open, close and acceptance dates for the bids. The computer-based method electronically posts all bids made by bidders on the products and services during the bid period. The system accepts the highest bid while excluding bids greater than the lowest high bid from a single bidder. The system further electronically consummates the sale. Each bid costs the bidder a predetermined amount of money. The system also provides an electronic bid, auction and sale game. The computer-based method also electronically posts all winning and accepted bids thereby documenting the sale of the plurality of products and services purchased by the bidders.

What would be desirable is an auction method that would enable the seller to make a significant profit on an item or service being sold and also enable a buyer to pay a significantly reduced price.

### SUMMARY OF THE INVENTION

An object of the present invention is to provide an auction method that would enable the seller to make a significant profit on an item or service being sold and also enable a buyer to pay a significantly reduced price.

Another object of the present invention is to provide an auction method that allows an individual the opportunity to purchase an item through an auction with a limit price.

One more object of the present invention is to provide an auction method that allows an individual to purchase an item for less than a fixed limit price.

An additional object of the present invention is to provide an auction method with a novel feature in which any bids that are the exact same amount are canceled out, the highest unmatched bid being the winner.

A further object of the present invention is to provide an auction method in which individuals pay a nominal fee to bid on an item.

A contributory object of the present invention is to provide an auction that has a set number of people that may bid on the item.

An added object of the present invention is to provide an auction that can be timed out after a certain number of days.

In brief, an auction method that allows an individual the opportunity to purchase an item through bidding on an auction with a fixed limit price. The auction method also allows an individual to purchase an item for less than a fixed limit price. A novel feature of the auction is that duplicate bids are canceled out. The item put up for auction has a set limit price and there are a set number of people that may bid on the item. Individuals pay a nominal fee to bid on that item. Individuals bid on that item at any price lower than the limit price. If more than one person bids the same amount on that item, his/her bids are eliminated, this process continues until the set number of people bid. The person with the highest unmatched bid will have the opportunity to buy that item for the price that he/she bid. The auction can also be timed out after a certain number of days.

An advantage of the present invention is that it allows the buyer to pay less than what they would if they bought the product for retail.

Another advantage of the present invention is that it provides a high income for the seller.

An additional advantage of the present invention is that the item being auctioned has a fixed price.

One more advantage of the present invention is that it provides a game-like element by eliminating duplicate bids.

### BEST MODE FOR CARRYING OUT THE INVENTION

An auction method for carrying out an auction sale is presented, which provides a high income to an auctioneer and a low cost to a bidder. The method comprises a first step of charging an admission price payable by each of a number of bidders to an auctioneer to enable each of the number of bidders to bid on one item at auction. The first step further comprises setting a limit on the number of bidders. The auction method also includes a second step of setting a maximum allowable bidding price for the item at auction. The method further comprises a third step of accepting a single bid not to exceed the maximum allowable bidding price from each of the bidders. The auction method also has a fourth step of allowing the bidder who has the highest unique unmatched bidding price, not exceeding the maximum allowable bidding price, to purchase the item at auction at the unique unmatched bidding price.

The auction method can be set up in a computerized program accessible through a computer network, preferably the World Wide Web. The auction method may also be formatted to run on a broadcast medium, in a print medium, in real time, via telephone or run live with the auctioneer and the bidders in the same physical location. The auction method further comprises setting a limit on the amount of time that the bidding is allowed.

The following is an example of how the auction method of the present invention would function in practice:

A 30″ television is put up for auction with a limit bid price of $500.00, well below the standard retail price. Two hundred people can bid on the television. Individuals pay $5.00 to bid on the 30″ television. Individuals may bid up to $500.00, but not more than $500.00. If John bids $433.33 and Sam also bids $433.33, those bids are eliminated. This process continues until 200 people bid. The person with the highest unmatched bid will buy the television for the price that he/she bid. If Amy bid $402.02 and no one else bid $402.02 and it is the highest unmatched bid she would buy the television for $402.02. This auction can also be timed out after a certain number of days.

It is understood that the preceding description is given merely by way of illustration and not in limitation of the invention and that various modifications may be made thereto without departing from the spirit of the invention as claimed.

What is claimed is:

1. An auction method for carrying out an auction sale providing a high income to an auctioneer and a low cost to a bidder, the method comprising:
a first step of charging an admission price payable by each of a number of bidders to an auctioneer to enable each of the number of bidders to bid on at least one item at auction;
a second step of setting a maximum allowable bidding price for the at least one item at auction;
a third step of accepting a single bid not to exceed the maximum allowable bidding price from each of the bidders;
a fourth step of allowing the bidder having a highest unique unmatched bidding price not exceeding the maximum allowable bidding price to purchase the at least one item at auction at the unique unmatched bidding price.

2. The auction method of claim 1 wherein the first step further comprises setting a limit on the number of bidders.

3. The auction method of claim 1 wherein the method is set up in a computerized program accessible through a computer network.

4. The auction method of claim 3 wherein the computer network is the World Wide Web.

5. The auction method of claim 1 wherein the auction method is formatted to be run on a broadcast medium.

6. The auction method of claim 1 wherein the auction method is formatted to be run in a print medium.

7. The auction method of claim 1 wherein the auction method is run in real time.

8. The auction method of claim 7 wherein the auction is run live with the auctioneer and the bidders in the same physical location.

9. The auction method of claim 1 wherein the auction method is formatted to be run via telephone.

10. The auction method of claim 1 further comprising setting a limit on the amount of time that the bidding is allowed.
